(19) United States
(12) Patent Application Publication
(10) Pub. No.: US 2001/0015980 A1
(43) Pub. Date: Aug. 23, 2001

(54) Mapping of dynamic synchronous transfer mode network onto an optical network

(75) Inventors: Lars Hakan Ramfelt, Palo Alto, CA (US); Magnus Svevar, Sunnyvale, CA (US); Jesper Echardt, Mountain View, CA (US)

Correspondence Address: Rolf Fasth, FASTH LAW OFFICES, 5255 Camelot Forest Drive, Jacksonville, FL, 32258-2516, US

(73) Assignee: Dynarc Inc. DBA Dynamic Network Architecture Inc.

(21) Appl. No.: 09/756,352

(22) Filed: Jan. 8, 2001

Related U.S. Application Data
(63) Continuation-in-part of application No. 09/464,032, filed on Dec. 15, 1999.
Application No. 09/464,032 is a continuation-in-part of application No. 09/062,524, filed on Apr. 17, 1998, now Pat. No. 6,108,338.

(51) Int. Cl. H04J 3/16

(52) U.S. Cl. 370/404; 370/466

(57) ABSTRACT

A device and method for mapping 65-bit DTM slots onto an optical network system that is based on bytes of 8 bits is described. The 64 data bits of each DTM slot are separated from the single control bit. The data bits are then grouped into a set of 8-bit bytes while all the single control bits are grouped into separate control byte groups. The separation of the data bytes from the control bytes eliminates the need for 8B10B encoding and the number of DTM slots may be adapted to the particular optical network used so that the number of bits of the DTM slots is an integral multiple of the size of the optical network interface.

PRIOR APPLICATION

This application is a continuation-in-part patent application of U.S. patent application No. 09/464,032; filed Dec. 15, 1999, which is a continuation-in-part patent application of No. 09/062,524; filed Apr. 17, 1998.

### TECHNICAL FIELD

The present invention relates to a device and method for mapping a dynamic synchronous transfer mode (DTM) network onto an optical network such as synchronous optical network (SONET) or synchronous digital hierarchy (SDH).

### BACKGROUND AND SUMMARY OF THE INVENTION

The next generation of networks are likely to integrate services such as delay-insensitive asynchronous applications including fax, mail, and file transfer with delay-sensitive applications having real-time requirements including audio and video. Today, data may be transmitted in optical telecommunication systems that rely on, for example, synchronous optical network (SONET) or synchronous digital hierarchy (SDH) as the standard transport infrastructure.

Data may be transmitted faster and more reliable with DTM which is a broadband network architecture. DTM combines many of the advantages of circuit-switching and packet-switching in that DTM is based on fast circuit-switching augmented with a dynamic reallocation of resources, good support for multi-cast channels and DTM has means for providing short access delay.

SONET is a standard for optical telecommunications transport in the United States and other countries. The SONET standard is expected to provide the transport infrastructure for worldwide telecommunications for the next decades. Synchronous digital hierarchy (SDH) is another commonly used standard. For simplicity, SONET is used as an example of a currently used optical telecommunications transport. SONET has overhead and payload bytes so that the overhead bytes permit management of the payload bytes on an individual basis and facilitate centralized fault sectionalization. The standard is preferred because it simplifies the interface to digital switches compared to older telecommunication systems. The signals in SONET are synchronous so that digital transitions in the signals occur at exactly the same rate. However, there may be some phase differences in the network due to propagation time delays or jitter introduced into the transmission network. SONET is particularly useful for end-to-end network management.

The present invention is a dynamic synchronous transfer mode router/switch architecture, such as DTM frames, that may conveniently be mapped onto any suitable optical network, such as SONET, so that no undesirable drifting of the DTM frames within the SONET frames may occur. The present invention may be applied to any mapping of DTM frames or other types of frames that are set onto an optical network system, such as SONET, where the interface size of the optical network is not an integral multiple of the number of slots in the frames to be mapped.

More particularly, the present invention is a device and method for mapping, for example, 65-bit slots, such as DTM slots, onto an optical network system that is based on bytes of 8 bits. For example, the 64 data bits of each DTM slot may be separated from the single control bit. The data bits are then grouped into a set of 8-bit bytes while all the single control bits from each 65-bit DTM slot are grouped into separate control byte groups. The separation of the data bytes from the control byte eliminates the need for 8B10B encoding and the number of DTM slots may be adapted to the particular optical network used so that the number of bits of a group of DTM slots is an integer of the payload of the optical network. Any undesirable drifting of the DTM frames within the optical network is thus reduced or even eliminated. In general, the separated bits that form the control byte group may include not only control bits but also data bits and any other type of suitable bits.

### BRIEF DESCRIPTION OF THE DRAWINGS

FIG. 1 is a schematic view of a dual DTM ring topology of the present invention;

FIG. 2 is a schematic view of a ring topology showing three separate channels;

FIG. 3 is a schematic view of the DTM ring topology of the present invention showing slot reuse of different segments;

FIG. 4 is a schematic view of a DTM cycle having a start slot;

FIG. 5 is a schematic view of a SONET frame;

FIG. 6 is a schematic view of mapping 65-bit DTM slots onto the SONET frame;

FIG. 7 is a schematic view of grouping 64-bit DTM payload slots and 64-bit DTM control slots; and

FIG. 8 is a schematic detailed view of the 64-bit control slots in FIG. 7.

### DETAILED DESCRIPTION

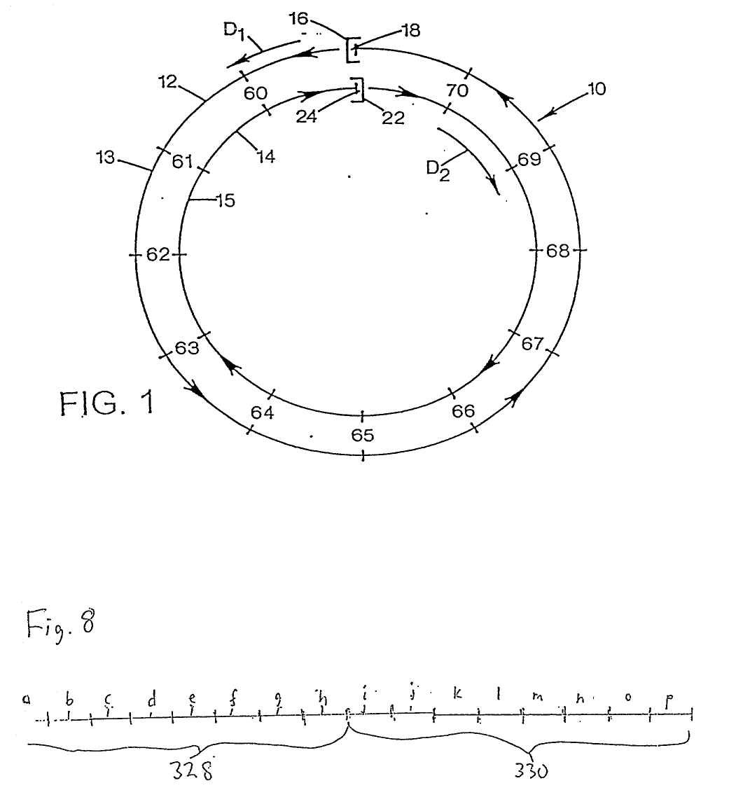

With reference to FIG. 1, the present invention may include a dynamic synchronous transfer mode (DTM) ring topology system 10 having a first ring topology 12 and a second ring topology 14. The total capacity of the ring topologies 12, 14 may be divided into cycles of 125 microseconds which are further dividable into 64-bit slots. It should be understood that the present may be used for mapping any type of topology system and DTM is only used as an example to illustrate the principles and features of the present invention.

One feature of the DTM ring topologies 12, 14 is that the cycle time and the slot length are, preferably, constant throughout the DTM ring topologies 12, 14. The DTM ring topologies 12, 14 are designed for a unidirectional medium with multiple access such as fiber optics medium 13, 15 having a capacity that is shared by all the connected nodes. The slots may be dynamically allocated between the nodes, as required.

The first ring topology 12 may be adapted to transfer data in a first rotational direction, as shown by an arrow D1, such as in a counter-clockwise direction, and the second ring topology 14 may be adapted to transfer data in a second rotational direction, as shown by an arrow D2, such as in a clockwise direction. Both the first and second ring topologies 12, 14, preferably, have an effective length that is an integral multiple of 125 microseconds long cycles.

The first ring topology 12 may comprise an expansion node 16 that may be used to precisely adjust the effective length of the ring topology 12 although the physical length of the ring topology 12 is not an integral multiple of the cycle time. The expansion node 16 may include an expandable buffer segment such as a FIFO (first-in-first-out) queue 18 for storing incoming cycles or frames of time slots.

The first ring topology 12 preferably has a plurality of nodes 60-70 and at least one of the nodes is selected as the expansion node 16. Similarly, the second ring topology 14 preferably comprises an expansion node 22 that may be used to precisely adjust the effective length of the second ring topology 14. The expansion node 22 may include an expandable FIFO queue 24 to optimize the use of the expansion node 22 and to properly synchronize the incoming cycles or frames in the expansion node 22.

All the connected nodes 60-70 and the expansion nodes 16, 22 in the ring topologies 12, 14 may share all the available data slots. The position of a particular set of slots in the cycles may be used to determine which of the nodes have access to the particular set of slots. In other words, a data slot is always owned by exactly one node at a particular time and only the owner of a data slot at a particular time may use the data slot to send information on a specific segment. If slot reuse is used, then the same slot may be used simultaneously by more than one user but on different segments of the ring topologies 12, 14.

As noted above, one important feature of the present invention is that the cycle time is preferably constant to maintain the synchronization of the entire ring topology system 10. Additionally, each cycle has a constant number of slots although each slot in every cycle may or may not contain any information.

If a slot reuse method is used, a single slot may be used multiple times on the ring topologies. Slot reuse enables simultaneous transmissions in the same slot over disjoint segments of the ring topologies 12, 14. Slot reuse may be described as a general method to better utilize shared links in the ring topologies 12, 14.

To allow slot reuse in DTM, the block token format may be extended to include parameters describing the segments it is representing. The token management protocol may also be modified to avoid conflicts in the slot number dimension as well as the segment dimension.

The capacity of the system depends partly on the bit rate per second of the particular fiber optics used. For example, the bit rate per second may be a fixed value such as 1 billion bits per second. Of course, the bit rate per second may be a higher value or a lower value. The higher the bit rate of the fiber optics the more slots per 125 microseconds cycle. As explained in detail below, the actual throughput of the ring topology system 10 may be higher than the bit rate of the fiber optics 13, 15 by reusing slots in the ring topologies 12, 14 in certain segments of the ring topologies. In other words, the same slots may be used by different users in different segments of the ring topologies so that a slot may be used more than once. However, the number of slots per cycle does not increase only the number of times the slots are used to send frames if the number of slots required by the messages or channels exceeds the number of slots in the cycle.

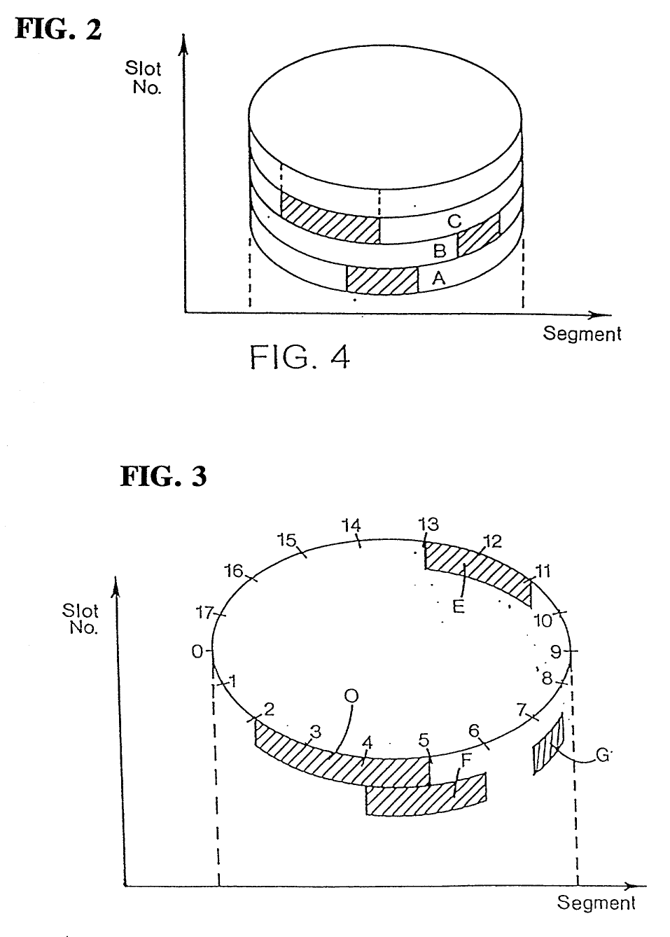

A suitable protocol may guarantee that a data slot can never be used by two nodes simultaneously on the ring topology. Sometimes this protocol is too conservative. FIG. 2 shows an example of how three tokens (A, B, and C) are reserved for three channels. The nodes are connected by segments and channels typically use a subset of the segments on the ring structure (gray color) and the rest are reserved (white color) but left unused and thus wasting shared resources. A better alternative is to let the channels only reserve capacity on the segments between the sender and the receiver as the example illustrated in FIG. 3. A single slot may in this case be used multiple times on the ring topology. Channel D is using the same slots as channel E but on different segments. Similarly, channel F and channel G use the same slots but on different segments. This is referred to as slot reuse. Slot reuse enables simultaneous transmissions in the same slot over disjointed segments of the ring topology. Because the ring topology is round, it is also possible to reserve slots from the end segments to the start segment, such as from segment 16 to segment 2. This is an added feature of ring structures that is not available in single or dual straight bus topologies.

As best shown in FIG. 4, a DTM cycle 300 may be an integral number of DTM slots 302 approximating a time period of 125 us. It is to be understood that the present invention may be applied to map any network system, such as DTM frames, onto any optical network system where the interface size of the network system to be mapped is a non-integral multiple of the interface size of the optical network. DTM frames are used as an example of the suitable network type that may be used.

Each DTM slot 302 includes 64 bits of a payload 303 containing data bits and a single control bit 305 of control information thus resulting in 65 bits of information per DTM slot. The single bit of control information may be used to transfer control information related to SAR framing, SAR-idle suppression and other information related to the DTM frame. For example, the control information in the control bit 305 may be used to indicate the end of a packet and to indicate the beginning and/or the end of DTM frames at other levels in the system.

A first start slot 304 may define the beginning of the cycle 300 and a last slot 306 may be the last idle slot that is located before a subsequent second start slot 308. As discussed below, the specific number of slots in a DTM frame 310 depends upon the link capacity of the network system. The number of slots within the DTM frame 310 is always equal to or smaller than the total number of slots in the cycle 300. The slots disposed after a last slot 312 of the DTM frame 310 are called gap slots (or frame idle slots) 314. The number of gap slots 314 are not fixed and may be increased and decreased to adjust an actual cycle time so that it closely matches a 125 microseconds reference clock. The procedure of adjusting the number of gap slots to the reference clock is sometimes call slot stuffing and is similar to byte stuffing used in many optical network systems.

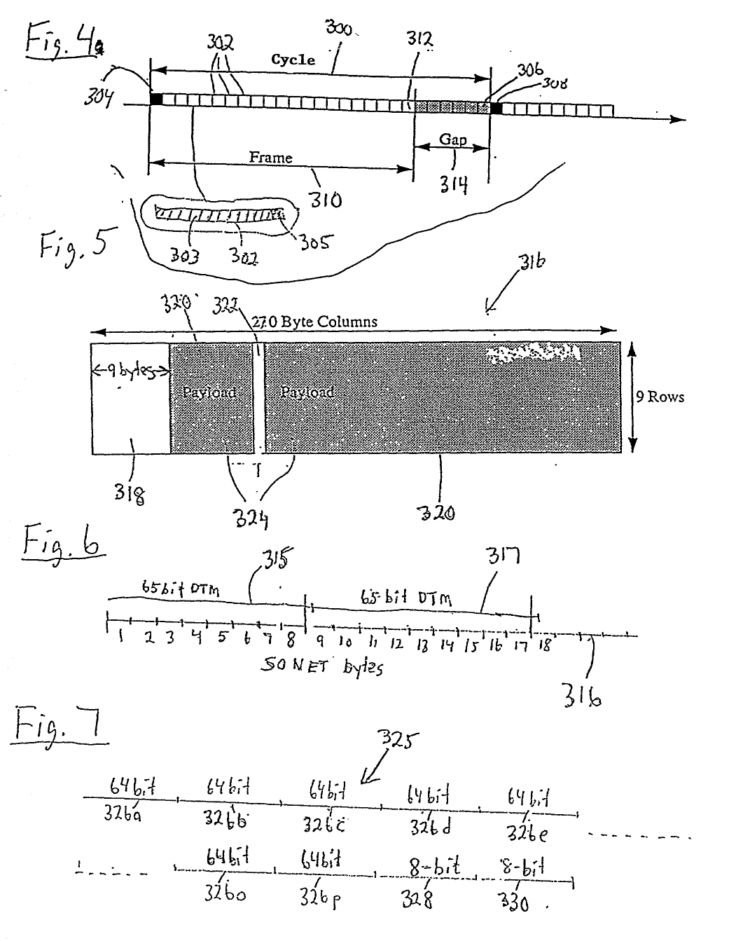

With reference to FIG. 5, a typical optical network system, such as synchronous optical network (SONET), uses a 125 microseconds frame 316 that is formatted with three different logical parts including transport overhead 318, payload 320 and path overhead 322. It is to be understood that the present invention may be used in connection with any suitable network including, but not limited to, synchronous optical network (SONET), synchronous digital hierarchy (SDH) or any other suitable network system. The SONET standard is used as an example to illustrate the principles of the present invention.

The frame format of a base signal STS-1 in SONET can be divided into transport overhead and synchronous payload envelope (SPE). STS-1 is a specific sequence of 810 bytes (6480 bits) and includes overhead bytes and an envelope capacity for transporting payloads. The three first columns of the STS-1 frame are the transport overhead. STS-3, STS-12, STS-48 are examples of other levels with higher payload capacities.

One low level signal of SONET is the synchronous transport signal level 3, or STS-3. This STS frame format is composed of 9 rows of 270 columns of 8-bit bytes. The byte transmission order is row-by-row, left to right. At a rate of 8000 frames per second, which works out to be a equivalent to a rate of 155.52 Mbps, as the following equation demonstrates:

9×270 bytes/frame×8 bits/byte×8000 frames/s=155.52 Mbps.

This is known as the STS-3 signal rate, i.e. the electrical rate used primarily for transport within a specific piece of hardware. The optical equivalent of STS-3 is known as OC-3 and it is used for transmission across the fiber. The typical SONET frame 316 has the transport overhead 318 that is independent of any data contained in the payload 320. For example, the STS-3 frame has 9 columns and 9 rows of the transport overhead 318 so that the transport overhead 318 is 81 bytes. The transport overhead 318 includes a byte stuffing procedure that may be used to compensate for minor differences in frequencies between oscillators. The frame 316 also has the path overhead 322 that is a column of bytes transported inside a virtual container 324 for carrying end-to-end information. The payload type carried inside the payload 320 may be indicated in a single byte in the path overhead 322. The end-to-end data path provided by the SONET system may be seen as a constant capacity pipe between two termination devices.

The SONET payload 320 must be scrambled in order to guarantee the bit level synchronization at each receiver. ATM and Packet over SONET payloads are examples of such scrambling.

An important feature of the present invention is the ability to map the DTM frame 310 over the SONET frame 316 so that DTM frames 310 may be sent from one point to another using the format of the SONET frame 316 without relying on 8B10B encoded links. With 8B10B encoded link 64+1 bit DTM slots are encoded into 80 bit slots. This results in 16 bits of overhead, which on top of the overhead associated with the SONET link format is unacceptable. In other words, for the SONET frame 316 that carries 8-bit bytes, a 65-bit DTM slot is not easily encapsulated without creating an unacceptable amount of overhead.

By encoding the DTM slots, according to the present invention, the 8B10B encoding may be eliminated. A DTM to SONET mapper according to the present invention only needs to map the DTM frame content and the SONET byte stuffing is provided by the SONET layer and will not be required by the DTM layer.

As shown in FIG. 6, the direct mapping of 65-bit DTM slots, without any encoding, creates undesirable drifting of the DTM slots within the SONET frame 316 that is built up in 8-bit bytes. The drifting of the DTM slots means that the start of each DTM slot is gradually shifted within the SONET frames 316. For example, the first 65-bit DTM slot 315 extends from the start of the SONET frame 316 to the first bit of the 9th byte of the SONET frame 316. A second 65-bit DTM slot 317 extends from the 2nd bit of the 9th byte to the 3rd bit of the 17th byte of the SONET frame 316 and so forth.

An important feature of the present invention is that the 65-bit DTM slots may be mapped directly onto the SONET frame 316 without causing any drifting of the DTM slots and without using any conventional encoders such as 8B10B links. Instead of considering single 65-bit DTM-slots, a group of 64 -bit DTM slots is transported together.

With reference to FIG. 7, a group 325 of 16 64-bit DTM slots 326a-326p are transported together followed by two bytes 328, 330 of 16 control bits. In other words, each 64-bit DTM slot has one control bit. As explained in detail below, because the DTM slots are grouped together into 130 bytes of DTM slots including the separately grouped control bits, the DTM slots may be transparently mapped onto the SONET frame 316. This simplifies the SERDES format but requires the buffering of the complete group at a sender or receiver. In general, the separated bits that form the control byte group may include not only control bits but also data bits. In other words, the present invention is not limited to separating the control bits from the data bits. It is also possible to separate data bits from other data bits.

In a sample implementation, a FIFO (first-in-first-out) buffer may be needed to store the 16 64 bit slots while the control byte group (16 control bits) is being built up in a register. The FIFO buffering may occur at either the sender or the receiver, but should preferably be present at either the sender or receiver depending on whether the control bytes are sent before or after the date bytes. Preferably, the FIFO buffer should have a minimum size to accommodate the 16 64 bit slots but may be larger.

By grouping the control bits separately from the 64 bits of data slots, each and every DTM bit of a string of DTM slots will be in the same position in subsequent SONET frames. For example, DTM bit number 4 will always be in the 4th bit of the 1st byte in the SONET frame 316. Similarly, DTM bit number 23 will always be in the 7th bit of the 3rd byte in the SONET frame 316 and no drifting of the DTM bits in the SONET frame 316 takes place.

FIG. 8 shows details of the control bytes 328 and 330. It should be noted that a first bit (a) of the byte 328 is the control bit associated with the DTM slot 326a in FIG. 7. The second bit (b) of the byte 328 is the control bit associated with the DTM slot 326b. Similarly, the 16th bit (p) of the byte 330 is the control bit associated with the DTM slot 326p of the DTM group 325. In this way, all the control bits of the DTM slots 326a-p are placed in the DTM control byte groups 328, 330.

For example, the DTM group 325 contains 16 DTM 64-bit slots for carrying a payload. This equals to 16 slots×64 bits=16×8 bytes which builds a 128 byte DTM group of DTM bits. As explained above, each DTM slot had 64 bits for carrying a payload and an extra control bit (the 65th bit in each slot). The control bits form the control byte groups 328, 330 that include 16 bits of a control byte group which is equivalent to 2 bytes of control bits. In this way, a total of 128 bytes of DTM data bits may carry payload and 2 bytes of DTM control bits together build the 130 byte DTM group 325.

A SONET STS-3 signals may carry a payload of 2340 bytes so that the STS-3 container may carry 18 DTM groups 325 since 2340 bytes/130 bytes=18. It is important to note that 18 DTM groups 325 are an integral multiple of the payload of STS-3 SONET container so that the SONET container may carry the 18 DTM group 325 without creating an undesirable drifting of the DTM frames in the SONET frame 316. In this way, the DTM overhead is therefore only 1/65 or 1.54%.

By encoding the DTM frames according to the current invention, the number of DTM slots are always fixed for a specific SONET container. For example, the STS-3 SONET container may carry 288 65-bit DTM slots wherein the DTM slots are grouped into 16 segments of 64-bit DTM data slots for carrying the payload and 2 bytes of DTM control slots for carrying 16 bits of control bits that are associated with the payload carrying 64-bit DTM slots 326a-326p.

Similarly, a 622 Mbps SONET system, such as STS-12, has a payload capacity of 9360 bytes and may carry 72 DTM 130 byte groups which is equivalent to 1152 65-bit DTM slots. A 2.4 Gbps SONET system, such as STS-48, has a payload capacity of 37440 bytes and may carry 4680 65-bit DTM slots. Since the capacity of the STS-12 SONET container is so large, it may be practical to increase the DTM group size from 130 bytes to 520 bytes.

While the present invention has been described with reference to preferred embodiments, it is to be understood that certain substitutions and alterations may be made thereto without departing from the spirit and scope of the invention as set forth in the appended claims.

We claim:

1. A method of mapping a dynamic synchronous transfer mode (DTM) frame onto an optical network frame, comprising:
(a) providing a dynamic transfer mode ring topology comprising a first node, a second node, a third node and a fourth node, a first segment of the dynamic transfer mode ring topology extending from the fourth node to the first node, a second segment of the dynamic transfer mode ring topology extending from the second node to the third node so that the second segment is being disjointed from the first segment, the dynamic transfer mode ring topology carrying a plurality of (n)-bits of DTM slots each having (n-1) data bits and (1) control bit, an optical network in communication with the dynamic transfer mode ring topology, the optical network having an (m)-bit frame format, (n-1) and (m) being integers so that (n-1) is an integral multiple of (m) and (n) is a non-integral multiple of (m);
(b) grouping the data bits into (m)-bit data groups;
(c) grouping the control bits into (m)-bit control groups, the data bytes being separate from the control bytes;
(d) forming a DTM set of the data groups and the control groups;
(e) mapping the DTM set onto an optical network frame on the optical network; and
(f) simultaneously transmitting information in a first data slot over the first and second disjointed segments of the dynamic transfer mode ring topology.

2. The method according to claim 1 wherein step (a) further comprises providing 65-bit DTM slots each having 64 data bits and 1 control bit and step (b) further comprises grouping the data bits into 8-bit data bytes and step (c) further comprises grouping the control bits into 8-bit control bytes.

3. The method according to claim 2 wherein the method further comprises associating a first control bit of the control bytes with a first DTM data bit of the 8-bit data bytes.

4. The method according to claim 1 wherein step (d) further comprises providing the DTM set with a bit configuration that is an integral multiple of an (m)-bit frame format of the optical network.

5. The method according to claim 1 wherein the method further comprises providing the optical network with a payload capacity that is an integral multiple of a total size of the DTM set.

6. A method of mapping a dynamic synchronous transfer mode (DTM) frame onto an optical network frame, comprising:
(a) providing a DTM topology having a first node, a second node, a third node and a fourth node, a first segment in the first dynamic transfer mode ring topology extending from the first node to the second node, the DTM topology carrying a plurality of 65-bit DTM slots each having 64 data bits and 1 control bit;
(b) grouping the data bits into 8-bit data bytes;
(c) grouping the control bits into 8-bit control bytes, the data bytes being separate from the control bytes;
(d) forming a DTM set of the groupings of data bytes and the control bytes;
(e) connecting the DTM topology to a synchronous optical network having a 8-bit frame format;
(f) mapping the DTM set onto the 8-bit frame format of the synchronous optical network; and
(g) transmitting the DTM set in the optical network frame without drifting the DTM set in the 8-bit frame format of the synchronous optical network.

7. The method according to claim 6 wherein the method further comprises associating each control bit of the control bytes with a group of data bytes so that a first control bit is associated with a first group of 64 data bits and a second control bit is associated with a second group of 64 data bits.

8. The method according to claim 6 wherein the method further comprises providing the DTM set with 128 bytes of data bits and 2 bytes of control bites and grouping the 128 bytes of data bits together into DTM slots each having 64 bits of data bits.

9. The method according to claim 1 wherein the method further comprises providing the optical network with a payload frame capacity that is an integral multiple of a total bit size of the DTM set.
